(19) United States
(12) Patent Application Publication
(10) Pub. No.: US 2003/0075583 A1
(43) Pub. Date: Apr. 24, 2003

(54) Nailing gun

(76) Inventor: Yung Chen Juan, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/981,730

(22) Filed: Oct. 19, 2001

(51) Int. Cl. B25C 1/04

(52) U.S. Cl. 227/130

(57) ABSTRACT

A nailing gun is formed with a cylinder. The cylinder has an inner wall. The inner wall has a plurality of exhausting holes. The cylinder has a piston. The piston is connected to a piston rod. The periphery of the piston has at least one annular groove. The annular groove has an O ring and a C ring therein. The C ring and O ring are arranged radially. The C ring is positioned at the outer side of the O ring and encloses the O ring. When the piston is installed in the cylinder, the C ring is resisted by the elastic force of the O ring. Because of the confinement of the inner wall of the cylinder, the tilt opening will close so that the C ring resists against the inner wall of the piston to be tightly adhered to the inner wall.

### FIELD OF THE INVENTION

The present invention relates to a nailing gun, wherein the nail is nailed pneumatically, and the piston and cylinder are tightly engaged so that it may resist against a larger pressure, and thus can be used in a hard material.

### BACKGROUND OF THE INVENTION

Currently, gunpowder nailing guns are used in nailing a nail into a hard work piece. The gunpowder is filled in the machine body. As the gunpowder explodes, a strong force will push a piston to beat a nail. Since one gunpowder is used only for a nail, the gunpowder must be updated continuously for nailing a plurality of nails. Therefore, the operation is inconvenient.

Referring to FIG. 5, in the current pneumatic nailing gun, a cylinder 8 is installed. The periphery of the cylinder 8 has a plurality of exhausting holes 81 which are arranged annularly. A piston 9 is installed in the cylinder 8. The outer periphery of the piston 9 is installed with an O ring 10. The O ring 10 is made of soft material and is elastic. The piston 9 has a nail beater. In nailing, high pressure air flows into the cylinder 8 to push the piston 9 so that the beater beats the nail. Then, the air exhausts from the exhausting holes 81 so that the piston 9 is restored to the original position. Since the O ring 10 is elastic and thus the piston 9 is completely adhered to the cylinder 8. No air may drain out.

Referring to FIGS. 6A to 6C, since the O ring 10 is made of soft material and is elastic. When gas flows through the exhausting holes 81, it will expand slightly due to the elastic force of the O ring 10. As the piston 9 moves reciprocally continuously, the O ring 10 will be scraped by the edges of the exhausting holes. Especially, as the work piece is hard, a larger air pressure is necessary for generating a larger pushing force, thereby, the beater may move rapidly so as to generate a larger pushing force. However, since the piston 9 moves rapidly, the O ring 10 is scraped further. Thus air drains out and as a result, the pushing force become smaller. Consequently, it is difficult to nail the nail into a work piece. Therefore, the prior art pneumatic nailing gun is only suitable for wood plates or other low strength work pieces instead of being used in a hard material.

### SUMMARY OF THE INVENTION

Accordingly, the primary object of the present invention is to provide a nailing gun, wherein by the O ring and the C ring of the present invention, the piston is tightly engaged with the cylinder. As a result, a high power is generated by a high pressure air so that the piston is pushed. Thus, nail can be nailed into a hard work piece.

To achieve above objects, the present invention provides a nailing gun, wherein the nailing gun has a piston. The peripheral surface of the piston has an elastic O ring and a hard and rub-tolerant C ring at an outer side of the O ring, when the piston moves rapidly in the cylinder, it is prevented that the C ring is scrapped. By the elastic force of the O ring, the C ring is ejected outwards so that the C ring is completely combined with the inner wall of the cylinder. Do not worry about that any gap is formed between the piston and the inner wall of the cylinder or gas drains out because the C ring is scraped.

The various objects and advantages of the present invention will be more readily understood from the following detailed description when read in conjunction with the appended drawing.

### BRIEF DESCRIPTION OF THE DRAWINGS

FIG. 1 is a partial cross sectional view of the present invention.

FIG. 2 is an exploded perspective view showing the cylinder and piston of the present invention.

FIG. 3A shows that in the present invention, the piston does not be mounted in the cylinder.

FIG. 3B shows that the piston is installed in the cylinder in the present invention.

FIG. 4A shows that in the present invention, a C ring passes through the exhausting hole.

FIG. 4B is an enlarged view showing that in the present invention, the heavy-duty paper-made stack plate passes through the exhausting hole.

FIG. 5 is a cross sectional view showing a prior art nailing gun.

FIGS. 6A to 6C shows that the piston of a prior nailing gun is scraped as it passes through the exhausting hole since the outer edge of the O ring expands.

### DETAILED DESCRIPTION OF THE PREFERRED EMBODIMENTS

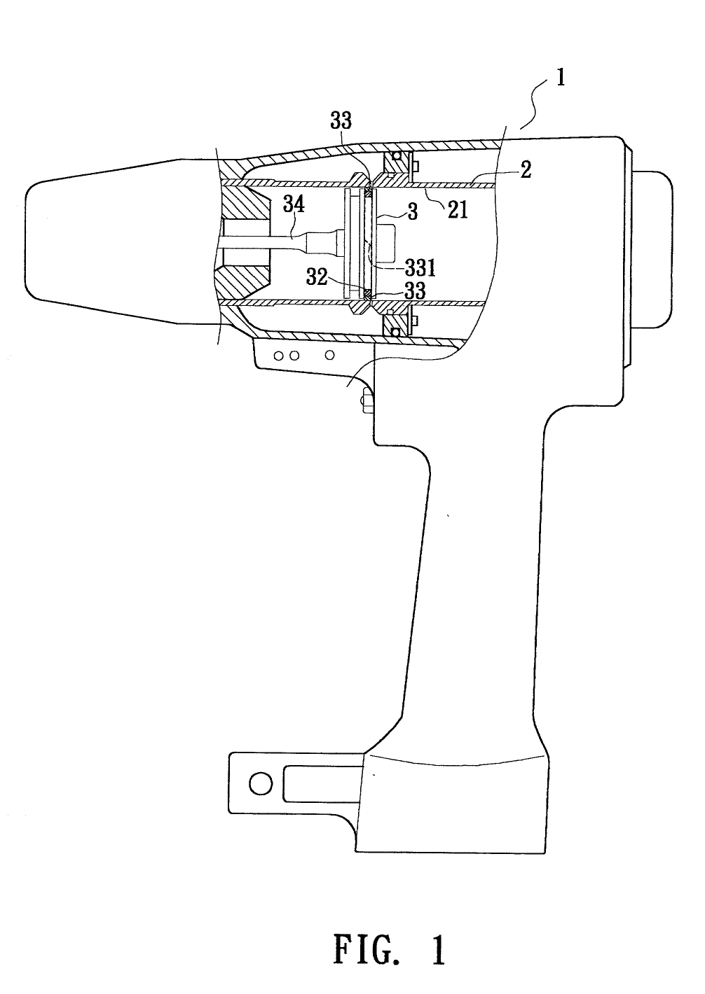

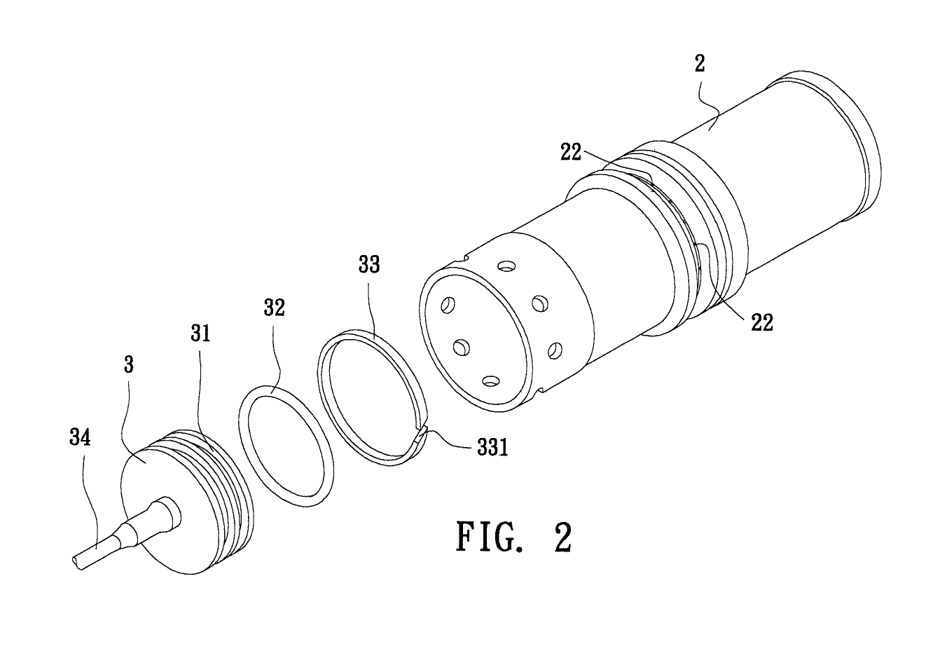

Referring to FIGS. 1 to 4, the nailing gun 1 of the present invention is illustrated. The nailing gun 1 is formed with a cylinder 2. The cylinder 2 has an inner wall 21. The inner wall 21 has a plurality of exhausting holes 22 which are annularly arranged along the peripheral wall of the exhausting holes 22. The cylinder 2 has a piston 3. The piston 3 is connected to a piston rod 34. The periphery of the piston 3 has at least one annular groove 31. The annular groove 31 has an O ring 32 and a C ring 33 therein. The C ring 33 and O ring 32 are arranged radially. The C ring 33 is positioned at the outer side of the O ring 32 and encloses the O ring 32. The inner diameter of the C ring 33 is smaller than that of the outer diameter of the O ring 32 and has a width corresponding to the width of the annular groove 31 for receiving the annular groove 31. The C ring 33 is made of hard rub-tolerant material (such as bakelite) and has a tilt opening 331. The O ring 32 is made of elastic materials (such as soft rubber).

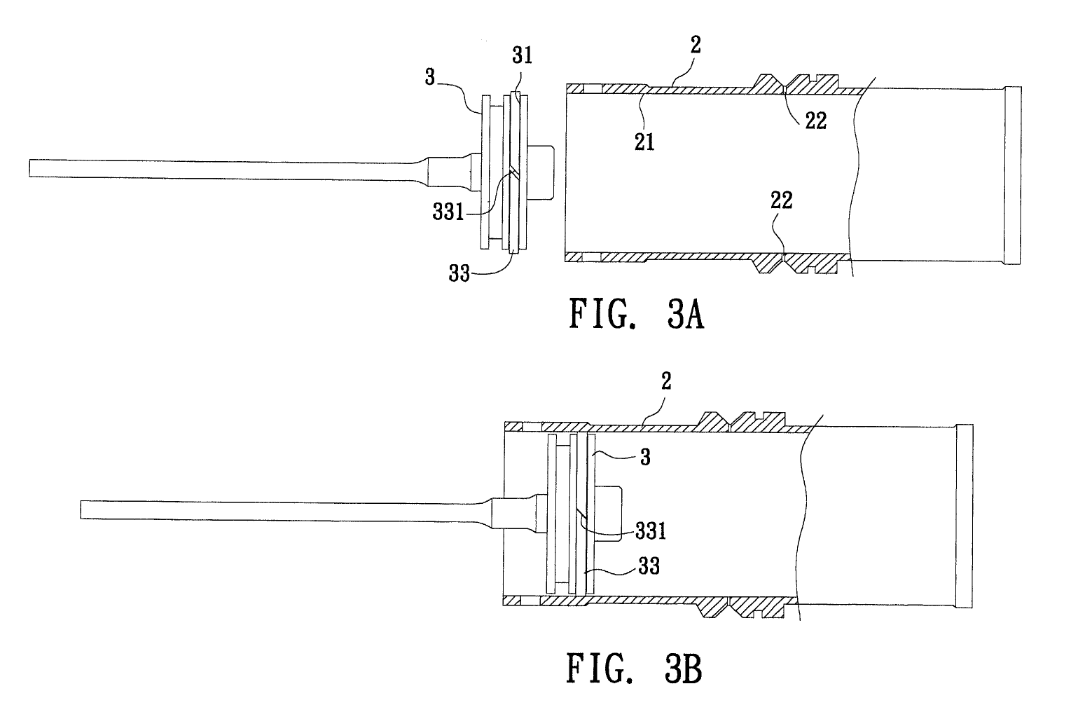

Referring to FIGS. 3A and 3B, since the inner diameter of the C ring 33 is smaller than that of the O ring 32, as the piston 3 is not installed in the cylinder 2, the C ring 33 will expand outwards slightly due to the pushing effect of the elastic O ring 32 so that the tilt opening 331 of the C ring 33 is opened. When the piston 3 is installed in the cylinder 2, the C ring 33 is resisted by the elastic force of the O ring 32. Because of the confinement of the inner wall 21 of the cylinder 2, the tilt opening 331 will close, and no gas drains out.

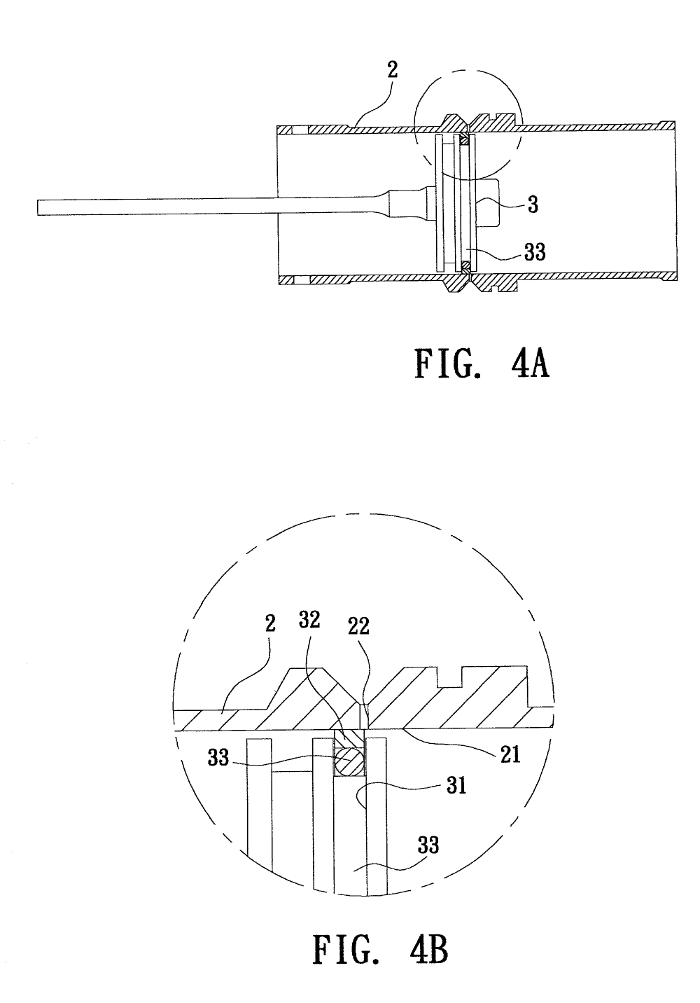

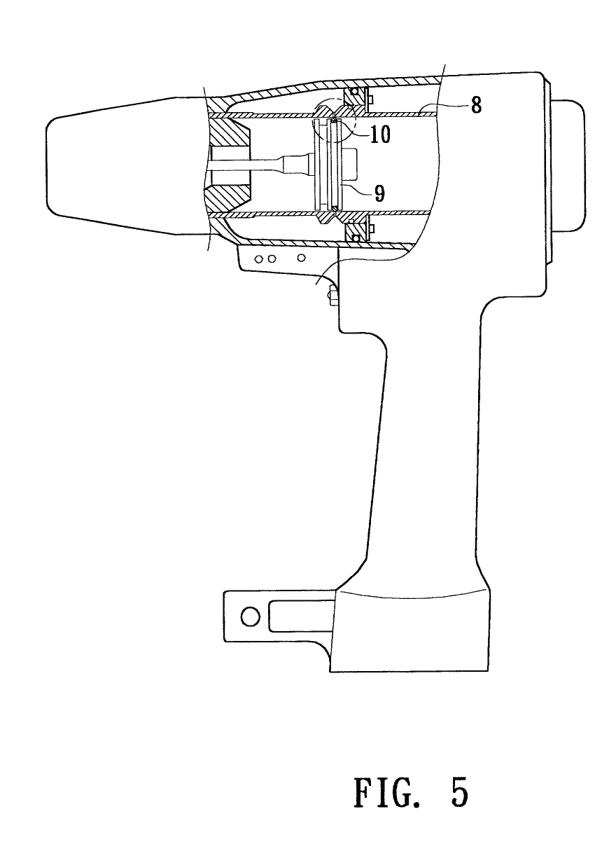

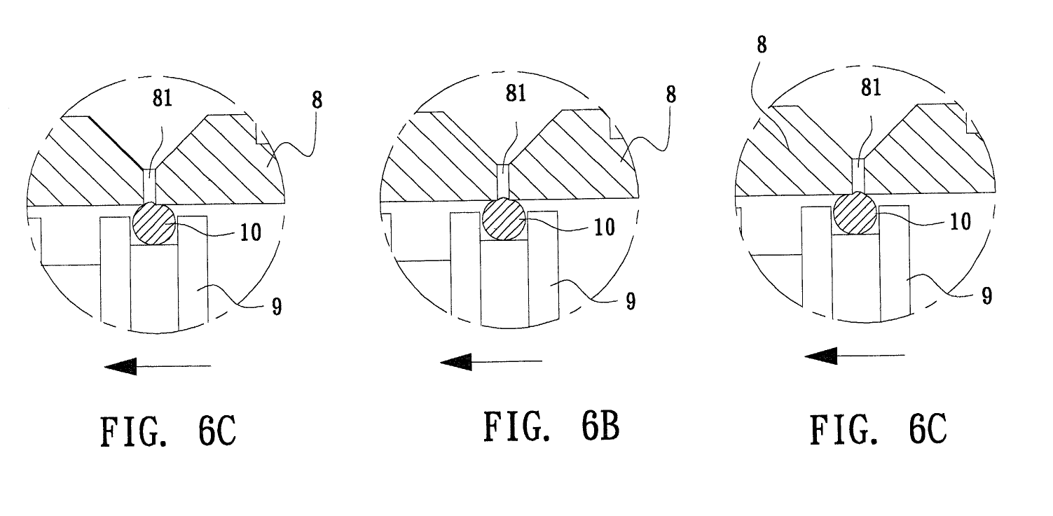

Referring to FIGS. 4A and 4B, when the C ring 33 passes through the exhausting hole 22 due to the rapid movement of the piston 3, since the C ring 33 is made of hard material, no gas drains out due to the scraping of the O ring 32 in the edge of the exhausting hole 22.

In summary, since in the present invention, the peripheral surface of the piston 3 has an elastic O ring 32 and a hard and rub-tolerant C ring 33 at an outer side of the O ring 32, when the piston 3 moves rapidly in the cylinder 2, it is prevented that the C ring 33 is scrapped. By he elastic force of the O ring 32, the C ring 33 is ejected outwards so that the C ring 33 is completely combined with the inner wall 21 of the cylinder 2. Do not worry about that any gap is formed between the piston 3 and the inner wall 21 of the cylinder 2 or gas drains out because the C ring 33 is scraped. Therefore, by the O ring 32 and the C ring 33 of the present invention, the piston 3 is tightly engaged with the cylinder 2. As a result, a high power is generated by a high pressure air so that the piston 3 is pushed. Thus, nail can be nailed into a hard work piece.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A nailing gun having a cylinder; the cylinder having an inner wall; the inner wall having a plurality of exhausting holes which radially penetrate exhausting holes in the inner wall, the cylinder having a piston; a periphery of the piston having at least one annular groove; the annular groove having an O ring and a C ring therein; the C ring and O ring being arranged radially; the C ring being positioned at an outer side of the O ring and enclosing the O ring; the C ring being resisted by an elastic force of the O ring so that the C ring resists against the inner wall of the piston to be tightly adhered to the inner wall.

2. The nailing gun as claimed in claim 1, wherein the C ring is made of bakelite.

3. The nailing gun as claimed in claim 1, wherein a peripheral surface of the C ring has a tilt opening, when the piston is installed in the cylinder, the opening will close due to the confinement of the inner wall of the piston.

4. The nailing gun as claimed in claim 1, wherein the C ring has a width corresponding to the width of the annular groove for receiving the annular groove.
